(19) United States
(12) Patent Application Publication
(10) Pub. No.: US 2020/0222859 A1
(43) Pub. Date: Jul. 16, 2020

(54) POROUS POLYMERIC HOLLOW FILTER MEMBRANE

(71) Applicant: ENTEGRIS, INC., Billerica, MA (US)

(72) Inventors: Rajni PATEL, Tewksbury, MA (US); Kwok-Shun CHENG, Nashua, NH (US); Brian Anthony GAGNON, North Billerica, MA (US); Ganapathysubramanian IYER, Woburn, MA (US)

(21) Appl. No.: 16/737,493

(22) Filed: Jan. 8, 2020

Related U.S. Application Data
(60) Provisional application No. 62/791,462, filed on Jan. 11, 2019.

(51) Int. Cl. B01D 69/08; B01D 71/02; B01D 71/34; B01D 71/36; B01D 71/26; B01D 71/68; B01D 69/02

(52) U.S. Cl. CPC B01D 69/087; B01D 71/022; B01D 71/34; B01D 69/02; B01D 71/26; B01D 71/68; B01D 71/36

(57) ABSTRACT

Described are hollow fiber porous polymeric filter membranes and methods for preparing these membranes. The methods including extruding and shaping a polymer solution that includes polymer and solvent, and reducing the temperature of the extruded polymer by contacting the extruded polymer with liquid metal.

This application claims the benefit of U.S. Application No. 62/791,462 filed on Jan. 11, 2019, which is hereby incorporated by reference in its entirety.

### FIELD OF THE INVENTION

The following description relates to porous polymeric filter membranes and methods for preparing such membranes. The methods include extruding a polymer solution that includes polymer and solvent, and reducing the temperature of the extruded polymer by contacting the extruded polymer with liquid metal. The filter membrane can exhibit desirable properties such as a relatively high bubble point.

### BACKGROUND

Filter membranes and filter products are indispensable tools of modern industry, used for removing unwanted materials (contaminants, particulates, impurities, and the like) from a flow of a useful fluid. Useful fluids that are processed using filters include water, liquid industrial solvents and processing fluids, industrial gases used for manufacturing, and liquids that have medical or pharmaceutical uses, among many others. Unwanted materials that are removed from fluids include impurities and contaminants such as particles, microorganisms, volatile organic materials, and chemical species contained in a gaseous or liquid fluid.

Features of a filter membrane such as chemical composition, size or dimensions, physical properties (e.g., porosity, pore size), and measured performance properties (e.g., “bubble point,” “flow time,” and the like) relate to overall filtering performance. Within present limits of the ranges of these features, a filter may include size (e.g., thickness), porosity, and pore size features that have a useful balance for filtering performance when used with a specific type of fluid and at a specific flow rate (by volume). Typical pore sizes are in the micron or sub-micron range, such as from about 0.001 micron to about 10 micron. Membranes with average pore size of from about 0.001 to about 0.05 micron are sometimes classified as ultrafilter membranes. Membranes with pore sizes between about 0.05 and 10 microns are sometimes classified as microporous membranes.

For commercial use, a filter membrane must be capable of performing as a filter in a manner that is efficient and reliable, e.g., must be capable of efficiently removing a high amount of impurities from a continuous flow of fluid that passes through the filter membrane. Filtering performance can be assessed, for example, by flow time (FT) and retention. Flow time is a measure of the rate of fluid that flows through a filter or filter membrane, and must be sufficient to allow for a filter to be used commercially. Retention refers to the amount (in percent) of impurities removed from a flow of fluid through a filter. Pore size and bubble point can affect flow time and retention. A membrane with smaller pores, which can be desirable to improve retention, can have a higher bubble point and a longer (but still useful) flow time. A larger pore size may correlate to relatively lower retention but shorter flow time and a lower bubble point. For commercial use, a filter membrane must provide a good combination of flow time, bubble point, and filtering performance.

Certain past versions of porous polymeric filter membranes that are useful for filtering liquids (e.g., semiconductor and microelectronic device processing liquids) include filter membranes made from ultrahigh molecular weight polyethylene (“UPE,” generally considered to have a molecular weight of at least 1,000,000 Daltons), e.g., by thermally-induced phase separation or “melt casting” techniques. Such UPE filter membranes may be prepared to exhibit a useful combination of liquid flow properties and good filtering performance. But presently-known techniques for manufacturing these filter membranes present limits on the degree to which these properties can be improved and balanced.

### SUMMARY

There is a present and ongoing need for porous filter membranes that have ever improved combinations of flow and filtering properties, which are dependent in large part on pore size. Increased bubble point and smaller pores can be desired to provide increased filtering effectiveness.

Current filter membranes, including polyethylene filter membranes, are prepared by various methods. Some of these conventional methods use a step of cooling a heated, shaped (extruded) polymer material by contacting a heated liquid polymer material with a liquid quench bath of water to cause the polymer material to solidify into a porous membrane. The size of the pores (and bubble point) of membranes prepared using these conventional techniques has been reduced (and bubble point increased) to a level that may be a lower limit by the use of conventional extrusion and cooling techniques for making the membranes.

According to the present description, it has been determined that a liquid metal may be advantageously used as a quench liquid, as a replacement for water. Water has a boiling point that is lower than a typical temperature of a heated and extruded polymer. This allows the water to form water vapor upon contact with the heated and extruded polymer. Vapors and gasses have the lowest thermal conductivity of all phases. Also, the thermal conductivity of water (and organic and inorganic liquids in general) by itself is very low as compared to metals (chill roll used for flat sheet quenching), making the water less efficient in cooling the melted polymer quickly enough to create small pores and a high bubble point membrane.

Accordingly, using a liquid metal as a quench bath can be useful or advantageous in forming a porous polymer filter membrane to have smaller pore size and higher bubble point, relative to a comparable filter membrane formed by an identical process and material, but with water as the quench bath liquid. The bubble point of the inventive membrane formed with a liquid metal quench bath may be at least 25, 50, 75, or 100 percent greater than the bubble point of the membrane formed with water as the quench bath.

In one aspect, the invention relates to a method of preparing a polymeric porous membrane. The method includes: extruding polymer solution comprising polymer and solvent, at an extrusion temperature, to form an extruded hollow fiber; and reducing the temperature of the extruded hollow fiber by contacting the extruded hollow fiber with a liquid metal.

In another aspect the invention relates to a method of preparing a polymeric porous membrane. The method includes: extruding polymer solution comprising polymer and solvent, at an extrusion temperature, to form an extruded hollow fiber, and reducing the temperature of the extruded hollow fiber by contacting the extruded hollow fiber with a liquid having a thermal conductivity of at least 3 watts per meter per degree Kelvin.

### BRIEF SUMMARY OF THE DRAWINGS

FIG. 1 is a schematic view of a method and system useful according to the present description.

FIGS. 2 and 3 show example embodiments of filter and components of a filter that include a composite hollow fiber filter membrane of the description.

### DETAILED DESCRIPTION

The following description relates to methods of making polymeric hollow fiber porous filter membranes, sometimes referred to herein for convenience simply as “membranes.” Examples of useful methods include those that include features of methods generally referred to as extrusion melt-cast processes, for example methods often referred to as “thermally-induced liquid-liquid phase separation” methods, further performed based on details described herein with respect to the use of a liquid metal quench bath.

According to example processes, polymer material that will form the filter membrane is dissolved in solvent at an elevated temperature (“extrusion temperature”) to form a heated polymer solution. Optionally, the solvent may be a single chemical type of solvent, or may be a combination of two or more different chemical solvent materials. The heated polymer solution is a homogeneous solution processed to the elevated temperature by blending the polymer with the solvent, e.g., in a heated extruder. The polymer solution is then shaped, e.g., by passing the polymer solution under pressure through a die. The extruded, shaped polymer material is then cooled in a liquid quench bath to induce a phase change (e.g., a liquid-liquid (L-L) phase separation) within the solution. The polymer forms a solidified, shaped polymer body that includes the solidified polymer material with small pores formed therein. The pores contain a portion of the original solvent, which is subsequently removed to leave the pores open.

General methods of this type have been used in the past to prepare porous membranes from a variety of polymeric materials including, but not limited to, polypropylene (PP), polyethylene (PE), fluorinated polymers such as polyvinylidene fluoride (PVDF), poly(ethylene-co-acrylic acid) (EAA), nylons, and polystyrene (PS). In past methods of this type, liquid quench baths have been made of water, organic solvent such as dioctyl phthalate or dibutyl sebacate, or an oil that is liquid at or near room temperature, such as a silicon oil or a liquid mineral oil

In contrast to previous, conventional methods, and according to the present description, it has been determined that these general types of heating and extrusion methods for preparing a porous polymeric hollow fiber membrane, including extrusion melt-cast processes, specifically including those referred to as “thermally-induced liquid-liquid phase separation” processes, can be performed with the use of a liquid metal as a liquid for a quench bath, instead of water. In specific, an extruded hollow fiber of polymer solution can be caused to flow from a die of an extruder and into a liquid quench bath that contains a liquid metal, to form a polymeric hollow fiber membrane.

The rate at which the heated polymer solution is cooled by the quench bath can have an effect on the ultimate form of the porous membrane, including the morphology of the porous membrane, which includes pore size. Under certain processing conditions that may be useful to form open-pore structures (as opposed to closed-pore structures), a slower rate of cooling the heated polymer solution can tend to cause the formation of larger pores in a filter membrane along with a lower bubble point; a relatively faster rate of cooling the heated polymer solution may result in smaller pores and a higher bubble point.

In some embodiments, a liquid metal, relative to other liquids such as water or oil, has been found to be advantageous as a liquid for a quench bath because a liquid metal has a much higher thermal conductivity. When the liquid metal is used as a quench bath, the higher thermal conductivity results in a faster rate of cooling of the heated polymer solution by the quench bath liquid, which can allow for smaller pores and a higher bubble point of a membrane as compared to the sizes of pores formed using a water quench bath at the same temperature.

For example, a liquid metal may have a thermal conductivity that is at least 3, 4, 5, or 6 watts per meter per degree Kelvin (W/mK). Water, for comparison, has a thermal conductivity of 0.6 W/mK. The increased thermal conductivity allows for heat from the extruded polymer to be removed more quickly by a liquid of a quench bath, providing a faster cooling rate for the polymer, which in turn results in smaller pores and a higher bubble point.

The liquid metal can have a melting point that allows the liquid metal to be useful for reducing a temperature of an extruded polymer solution in a quench bath. Example melting points of useful or preferred liquid metals can be below about 100 degrees Celsius, e.g., below 75 or below 50 degrees Celsius, or may preferably be liquid at or about room temperature (e.g., 20, 25, or 30 degrees Celsius).

The liquid metal may be composed of any single metal or an alloy of multiple different metals. Examples of metals that, alone or as part of a liquid metal alloy, can be liquid at a temperature below 100, 75, 50, or 25 degrees Celsius, include mercury, indium, gallium, tin, bismuth, lead, cadmium, and thallium. Examples of alloys that include a combination of two or more of these metals include liquid metal compositions known as “Rose's metal,” “Cerrosafe,” “Wood's metal,” “Field's metal,” “Cerrolow 136,” “Cerrolow 117,” “Bi—Pb—Sn—Cd—In—Tl,” “Indalloy®,” and “Galinstan.” Any of these or similar metal alloys may be effective for use as a liquid in a quench bath as described, due to having a low melting point and high thermal conductivity.

Liquid metal alloys that may be preferred are those that have a relatively low melting point, e.g., below 20, 25, 30, 35, or 40 degrees Celsius. These include Galinstan and alloys that have a similar or comparable chemical makeup. Galinstan can be considered to be a metal that is liquid at room temperature (e.g., 25 degrees Celsius) and that contains from 68 to 69 weight percent gallium, from 21 to 22 weight percent indium, from 9.5 to 10.5 weight percent tin, less than 1.5 weight percent bismuth, less than 1.5 weight percent antimony, and other optional amounts of additives such as zinc (e.g., at less than 1 percent). More generally, Galinstan and similar metal alloys that may be useful can be those that are liquid at below 50 or below 30 degrees Celsius and that contain: at least 50 weight percent gallium, at least 5 weight percent tin, and at least 10 weight percent indium; or that contain: from 65 to 72 weight percent gallium, from 5 to 15 weight percent tin, and from 15 to 25 weight percent indium.

As a liquid of a quench bath, liquid metal should make up a substantial portion of a total amount of liquid of the quench bath, e.g., the quench bath may contain at least 60, 70, 80, 90, 95, 98, or 99 weight percent liquid metal, based on total liquid in the quench bath. Other than the liquid metal, the quench bath may contain, for example due to accumulation during use, other processing fluids used in preparing the polymeric membrane, such as organic solvent (as described herein), oil, or water, in an amount that is up to 1, 2, 5, 10, or 20 weight percent.

In more detail, a method as described can include a step of preparing heated polymer solution to contain polymer (as described herein) dissolved in solvent. The solvent may be a single type of solvent or may be a combination of two different solvents which, in melt-cast extrusion processes, are sometimes referred to as a first (“strong”) solvent and a second (“weak”) solvent (a.k.a. “non-solvent” or “poragen”). The strong solvent is capable of substantially dissolving the polymer into the heated polymer solution. Examples of useful strong solvents include organic liquids in which a polymer is highly soluble at an extrusion temperature, and in which the polymer has a low solubility at a cooling temperature. Particular non-limiting examples of useful strong solvents include mineral oil and n-alkanes such as ditriactontane (C₃₂H₆₆).

The weak solvent is one in which the polymer has a low solubility at the extrusion temperature and at the cooling temperature, and that is miscible with the strong solvent at an extrusion temperature and is immiscible with the strong solvent at cooling temperature. Particular and non-limiting examples of weak solvents include dioctyl phthalate and dibutyl sebacate (DBS), and the class of fatty acids such as those having alkyl groups of at least ten carbon atoms C₁₄H₂₉OOH and C₁₉H₃₉OOH).

The amount of the polymer in the heated polymer solution can be an amount that is sufficiently high to allow for the heated polymer solution to be processed and shaped using an extruder and a die, and that is at the same time sufficient to allow the polymer in the polymer solution to coalesce and form into a desired porous morphology upon shaping and cooling. A useful or preferred amount of polymer in a heated polymer solution as described can be in a range from 10 to 40 weight percent, such as from 12 to 35 weight percent, based on total weight polymer solution. The balance of the heated polymer solution can be solvent, e.g., a combination of one or more weak solvents and one or more strong solvents. Thus, useful or preferred heated polymer solutions can contain, e.g., from 60 to 90 weight percent solvent (e.g., a combination of weak solvent and strong solvent), e.g., from 65 to 88 weight percent.

In a method that uses a combination of a strong solvent and a weak solvent, the relative amount of strong solvent to weak solvent can be selected as desired, to achieve a desired pore structure of a porous membrane. For UPE as the polymer, useful relative amounts of weak solvent to strong solvent can vary within ranges that include (weak solvent: strong solvent) from 10:90 to 90:10, from 20:80 to 80:20, from 25:75 to 75:25, and from 40:60 to 60:40. These ranges may be effective for other polymers as well, or other polymers may have useful or preferred ranges that are different.

A useful process, in more detail, can be based on a thermally-induced phase separation process that includes liquid-liquid phase separation of the weak solvent and the strong solvent (with dissolved polymer). According to such methods, a heated polymer solution that contains polymer dissolved in strong solvent, additionally in combination with a second solvent (referred to as a “weak solvent” or even a “non-solvent” or “poragen”), forms a homogeneous, heated polymer solution. This heated polymer material is characterized as having: a range of temperatures at which the heated polymer material maintains a state of a homogeneous solution of the polymer dissolved in the combination of the strong solvent and the weak solvent, and a second (lower) range of temperatures at which the solution will become phase separated.

By cooling the heated polymer solution from an elevated (“extrusion”) temperature to a reduced (“cooling”) temperature, the heated polymer solution initially separates into two liquid phases: a polymer-rich phase and a polymer-lean phase. When the solution is cooled to below a solidification temperature, the high-polymer-content phase solidifies to form a three-dimensional membrane structure. With sufficiently rapid cooling, small particles or droplets of the polymer-lean phase are formed within the solidified membrane structure, forming pores within the three-dimensional membrane structure.

According to example methods, the heated polymer solution formed from the polymer and solvent (e.g., weak and strong solvents), mixed to uniformity (homogeneity) in an extruder, is passed through an extrusion die to form the heated polymer solution into a desired shape. Many examples of extrusion equipment are known and commercially available and useful for forming a polymeric, porous, hollow fiber filter membrane. Conventional dies for shaping the extruded heated polymer solution, e.g., to form a hollow fiber membrane, are also known and will be understood to be useful according to the present description.

A useful or preferred extrusion temperature, i.e., the temperature of the heated polymer solution exiting an extruder die, can be in a range from 180 to 270 degrees Celsius, e.g., from 200 to 260 degrees Celsius.

The extruded heated polymer solution can be cooled by contacting the shaped extruded heated polymer solution with a quench bath as described, that contains the liquid metal. The temperature of the quench bath (i.e., the “cooling temperature”) must be below a temperature of the extruded heated polymer solution, e.g., not greater than 100 degrees Celsius. A useful or preferred cooling temperature can be in a range from 0 to 100 degrees Celsius, e.g., from 10 or 15 degrees Celsius to 50 or 60 degrees Celsius.

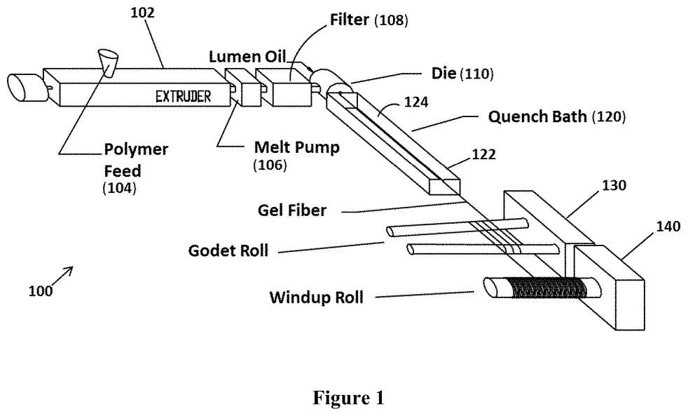

Referring to FIG. 1, illustrated is an example of a system for carrying out a method as described. System 100 includes extruder 102, pump 106, filter 108, die 110, quench bath 120 (including tub 122 and quench liquid 124 contained therein), godet roll 130, and windup roll 140. The system is shown schematically, and is not necessarily to scale.

In use, a polymer feed 104 is introduced to extruder 102, where the polymer feed is heated, mixed, and combined with solvent (not shown) as described herein to form a heated polymer solution. The combination of polymer and solvent (the polymer solution) is advanced through the extruder, (optionally) pumped and filtered using pump 106 and filter 108, and passed through die 110. As illustrated, die 110 is designed to shape the heated polymer solution into a hollow fiber (other shapes may also be found to be useful). A fluid is also introduced into the heated polymer solution, at the die, to form the hollow interior opening of the hollow fiber membrane; the fluid (e.g., “interior filler”) may be gaseous or liquid, e.g., an oil.

Upon exiting the die, the shaped heated polymer extrudate (in the form of a hollow fiber) enters quench bath 120 and is submerged in quench bath liquid 124 so that the liquid (a liquid metal as described) contacts the outer surfaces of the hollow fiber polymer extrudate. The cooled hollow fiber can be removed from the quench bath and processed as desired. For example, the cooled hollow fiber may be lengthened or extended using a “Godet roll,” and then wound onto a roll.

he polymer that is used to prepare the polymer solution and the polymeric membrane can be any polymer or blend of polymers that can be processed as described to form a porous polymeric membrane by: preparing the polymer solution that contains the polymer dissolved in solvent; shaping the polymer solution (e.g., by extruding and passing under pressure through a die); and cooling the shaped polymer solution in a liquid metal quench bath. The polymer should be chemically resistant to (e.g., not chemically degraded by) a liquid that will be passed through the filter membrane that is formed from the polymer, when the membrane is used in a filtering step. Useful examples include polymers that have been used or that are found to be useful as hollow fiber filter membranes for filtering fluids used in semiconductor and microelectronic processing (e.g., solvent or process fluids).

Examples of these types of polymers are known and include fluorinated (including partially fluorinated and perfluorinated) polymers such as polyvinylidene fluoride (PVDF), ethylene-tetrafluoro-ethylene (ETFE), fluorinated ethylene-propylene (FEP), as well as others; polyolefins such as polypropylene (PP), polyethylene (PE), high density polyethylene (HDPE) and blends or copolymers thereof; acrylate and methacrylate polymers and copolymers such as poly(ethylene-co-acrylic acid) (EAA); polystyrene (PS); polyamides and polyimides (e.g., nylons, especially those that are compatible with photolithography solvents used in semiconductor fabrication); polysulfones (e.g., polyethersulfone or “PES”); and copolymers and blends of these, among others.

In certain examples the polymer is polyethylene or a polyethylene blend. The term “polyethylene” refers to a polymer that has, in part or substantially, a linear molecular structure of repeating —CH₂—CH₂— units. Polyethylene can be made by reacting monomer composition that includes monomers comprising, consisting of, or consisting essentially of ethylene monomers. Thus, a polyethylene polymer may be a polyethylene homopolymer prepared by reacting monomers that consist of or consist essentially of ethylene monomers. Alternatively, a polyethylene polymer may be a polyethylene copolymer prepared by reacting a combination of ethylene and non-ethylene monomers that include, consist of, or consist essentially of ethylene monomers in combination with another type of monomer such as another alpha-olefin monomer, e.g., butene, hexene, or octane, or a combination of these. For a polyethylene copolymer, the amount of ethylene monomer used to produce the copolymer relative to non-ethylene monomers can be any useful amount, such as an amount of at least 50, 60, 70, 80, or 90 percent (by weight) ethylene monomer per total weight of all monomers (ethylene monomer and non-ethylene monomer) in a monomer composition used to prepare the ethylene copolymer.

As used herein, a composition (e.g., monomer composition) that is described as “consisting essentially of” a certain ingredient or a combination of specified ingredients is a composition that contains the ingredient or combination of specified ingredients and not more than a small or insignificant amount of other materials, e.g., not more than 3, 2, 1, 0.5, 0.1, or 0.05 weight percent of any other ingredient or combination of ingredients. A monomer composition described as containing monomers that “consist essentially of” ethylene monomers is a monomer composition that contains ethylene monomers and not more than a small or insignificant amount of other monomeric materials, e.g., not more than 3, 2, 1, 0.5, 0.1, or 0.05 weight percent of any other monomers.

One example of a general type of polyethylene that is considered to be useful for preparing a hollow fiber filter membrane according to the present description is ultra high molecular weight polyethylene (UPE). Ultra-high molecular weight polyethylene is a type of polyethylene that is well known and commonly used for preparing porous filter membranes. Ultra-high molecular weight polyethylene typically has a molecular weight of at least 1,000,000 Daltons. Molecular weight of a polymer reported in “Daltons” can be measured using known gel permeation chromatography (GPC) (also known as size-exclusion chromatography (SEC)) techniques and equipment.

A hollow fiber filter membrane prepared by a method as described can be effective for use as a filter membrane by allowing a useful fluid to pass through the membrane, in a useful amount and at a useful flow rate, while effectively removing unwanted contaminants or impurities from the fluid. The membrane is polymeric, porous, and has mechanical properties (e.g., is sufficiently rigid yet flexible) that allow for the membrane to be assembled into and used in the form of a filter product. The membrane has features such as porosity, pore size, thickness, and composition (i.e., polymeric makeup), that together contribute to the properties of the membrane, including performance properties (retention, flow time, among others). The membrane should be sufficiently porous, and with suitable pore size, to allow for liquid fluid to pass through the membrane at a flow rate that is sufficient for the membrane to be used in a commercial filtering application, while removing a high amount (e.g., percentage) of unwanted contaminants or impurities from the liquid.

The filter membrane is porous, and has an “open pore” structure that allows for a desired flow of fluid (e.g., liquid) from one surface of the filter membrane, through a thickness of the filter membrane, to the other side of the filter membrane. Between the two opposed surfaces, along the thickness of the membrane, are cellular, three-dimensional, void microstructures in the form of enclosed cells, i.e., “open cells” or “pores” that allow for fluid to pass through the thickness of the membrane. The open cells can be referred to as openings, pores, channels, or passageways, which are largely interconnected between adjacent cells to allow fluid to flow through the cells, between the cells, and through the thickness of the membrane.

The pores are distributed throughout the thickness of the membrane and may be arranged in any manner based on position, shape, and size, e.g., either uniformly or non-uniformly in these respects, such as having a symmetric, asymmetric, isotropic, or homogeneous morphology. A membrane that has pores of substantially uniform size uniformly distributed throughout the membrane is often referred to as isotropic, or “homogeneous.” An anisotropic (a.k.a., “asymmetric”) membrane may be considered to have a morphology in which a pore size gradient exists across the membrane; for example, the membrane may have a structure with relatively larger pores at one membrane surface, and relatively smaller pores at the other membrane surface. The term “asymmetric” is often used interchangeably with the term “anisotropic.”

A hollow fiber filter membrane can have thickness, inner diameter, and outer diameter dimensions that will be effective for a desired use of the filter membrane. Examples of useful thicknesses of a membrane may be in a range from 10 to 300 microns, e.g., from 50 or 100 microns to 200 microns. Examples of useful inner diameters of a membrane may be in a range from 50 to 1000 microns, e.g., from 200 to 500 microns. Examples of useful outer diameters of a membrane may be in a range from 300 to 2000 microns, e.g., from 300 to 800 microns.

The membrane can have a porosity that will allow the membrane to be effective as described herein, to allow a suitable flow rate of liquid to pass through the membrane while also removing a high level of contaminants or impurities from the liquid. Examples of useful membranes can have a porosity of up to 80 percent, e.g., a porosity in a range from 60 to 80, e.g., 60 to 70 percent or from 40 to 60 percent. As used herein, and in the art of porous bodies, a “porosity” of a porous body (also sometimes referred to as “void fraction”) is a measure of the void (i.e. “empty”) space in the body as a percent of the total volume of the body, and is calculated as a fraction of the volume of voids of the body over the total volume of the body. A body that has zero percent porosity is completely solid.

The size of the pores (“pore size”) of a membrane (i.e., the average size of pores throughout the membrane) can be a size that, in combination with the porosity, thickness, and inner and outer diameter dimensions of the membrane, provides for desired flow of liquid fluid through the membrane, while also performing a desired high level of a filtering. Advantageously, a pore size of a membrane prepared by a method as described, that uses a liquid metal as a quench bath liquid, can be smaller than a pore size (comparably measured) of a comparable membrane made using the same polymer solution, same extrusion and die conditions, and same quench bath temperature, but using water as the quench bath liquid.

A pore size that will be useful for a particular hollow fiber membrane can depend on factors such as: the thickness of the membrane; the desired flow properties (e.g., flow rate or “flow time”) of fluid through the membrane; desired level of filtering (e.g., as measured by “retention”); the particular type of fluid that will be processed (filtered) by passing through the membrane; the particular contaminant that will be removed from the fluid passing through the membrane; as well as other factors. For certain presently understood examples, useful pore sizes may be in a range from about 10, 20, 30 or nanometers, or 0.05 microns, up to about 10 microns, e.g., of sizes sometimes classified as “microporous,” “ultraporous,” or “nanoporous”; for purposes of the present description and claims, the term “microporous” is sometimes used to refer to pores within any of these size ranges, including microporous and sub-microporous sizes, as a way of distinguishing from materials having larger pore sizes, i.e., to distinguish over materials that are considered to be “macroporous.” Examples of average pore sizes of a membrane as described may be at least 10, 20, 30 nanometers or 50 nanometers, or at least 0.1 micron, e.g., from 0.1 to 0.5 microns, and up to about 4, 6, or 8 microns.

Pore size of a membrane may not necessarily be measured directly, but can be assessed based on a correlation to the property known as “bubble point,” which is an understood property of a porous filter membrane. Bubble point corresponds to pore size, which may correspond to filtering performance, e.g., as measured by retention. A smaller pore size can correlate to a higher bubble point and often to higher filtering performance (higher retention). Normally, however, a higher bubble point also correlates to relatively higher resistance of flow through a porous material, and a higher flow time (lower rate of flow for a given pressure drop). Example filter membranes of the present description can exhibit a combination of a relatively higher bubble point, good filtering performance, and a useful level of flow, e.g., a flow rate that allows for the filter membrane to be used in a commercial filtering process.

By one method of determining the bubble point of a porous material, a sample of the porous material is immersed in and wetted with a liquid having a known surface tension, and a gas pressure is applied to one side of the sample. The gas pressure is gradually increased. The minimum pressure at which the gas flows through the sample is called a bubble point.

According to the present description, by the use of a test method as presented herein, a bubble point of a particular porous filter membrane can be higher than (e.g., 25 percent greater than, 50 percent greater than, 80 percent greater than, or 100 percent greater than, when using identical test methods) a bubble point of a comparable (e.g., otherwise identical) filter membrane that is prepared by a comparable (e.g., otherwise identical) method but by using liquid metal as a quench liquid for the inventive (higher bubble point) membrane, as compared to water as the quench liquid for the comparable filter (lower bubble point) membrane.

Examples of useful bubble points of a porous filter membrane as described, measured using a test method described in the Examples, herein below, can be at least 50, 80, 90, 100, or 120 pounds per square inch (psi) or greater, e.g., up to 200 or 300 pounds per square inch, while the membrane also exhibits useful properties of flow time and retention as described elsewhere herein (measured using HFE-7200 (3M), at a temperature of 22 degrees Celsius).

In combination with a desired bubble point and filtering performance (e.g., measured by retention) a membrane as described can exhibit a useful resistance to flow of liquid through the membrane. A resistance to liquid flow can be measured in terms of flow rate or flow time (which is an inverse to flow rate). A membrane as described can preferably have a useful or a relatively low flow time, preferably in combination with a bubble point that is relatively high and good filtering performance. An example of a useful or preferred flow time can be below about 60,000 seconds, e.g., below about 50,000 or 40,000 seconds, when measured as described in the Examples section of the present description, herein below.

A level of effectiveness of a filter membrane in removing unwanted material (i.e., “contaminants”) from a liquid can be measured, in one fashion, as “retention.” Retention, with reference to the effectiveness of a filter membrane (e.g., a filter membrane as described), generally refers to a total amount of an impurity (actual or during a performance test) that is removed from a liquid that contains the impurity, relative to the total amount of the impurity that was in the liquid upon passing the liquid through the filter membrane. The “retention” value of a filter membrane is, thus, a percentage, with a filter that has a higher retention value (a higher percentage) being relatively more effective in removing particles from a liquid, and a filter that has a lower retention value (a lower percentage) being relatively less effective in removing particles from a liquid.

In example embodiments of membranes prepared according to examples methods of the present description described, a membrane can exhibit a retention that exceeds 50 percent for a monolayer coverage of 1.0%, as measured using the test described in the Examples section, with a useful flow rate through the membrane.

A filter membrane as described can be useful to remove contaminants from a liquid by passing the liquid through the filter membrane to produce a filtered (or “purified”) liquid. The filtered liquid will contain a reduced level of contaminants compared to the level of contaminants present in the liquid before the liquid is passed through the filter membrane.

A filter membrane as described herein, or a filter or filter component that contains the filter membrane, can be useful in a method of filtering a liquid chemical material to purify or otherwise remove unwanted material from the liquid chemical material, especially to produce a highly pure liquid chemical material that is useful for an industrial process that requires a chemical material input that has a very high level of purity. Generally, the liquid chemical may be any of various useful commercial materials, and may be a liquid chemical that is useful in any of a variety of different industrial or commercial applications. Particular examples of filter membranes as described can be used for purifying a liquid chemical that is used or useful in a semiconductor or microelectronic fabrication application, e.g., for filtering a liquid solvent or other process solution used in a method of semiconductor photolithography (e.g., a liquid photoresist solution), a wet etching or cleaning step, a method of forming spin-on-glass (SOG), for a backside anti-reflective coating (BARC) method, etc.

Some specific, non-limiting, examples of liquid solvents that can be filtered using a filter membrane as described include: n-butyl acetate (nBA), isopropyl alcohol (IPA), 2-ethoxyethyl acetate (2EEA), a xylene, cyclohexanone, ethyl lactate, gamma-butyrolactone, hexamethyldisilazane, methyl-2-hydroxyisobutyrate, methyl isobutyl carbinol (MIBC), n-butyl acetate, methyl isobutyl ketone (MIBK), isoamyl acetate, tetraethyl ammonium hydroxide (TMAH), propylene glycol monoethyl ether, propylene glycol methyl ether (PGME), 2-heptanone, cyclohexanone, and propylene glycol monomethyl ether acetate (PGMEA).

The membrane can be contained within a larger filter structure such as a filter housing or a filter cartridge that is used in a filtering system. The filtering system will place the membrane, e.g., as part of a filter or filter cartridge, in a flow path of a liquid chemical to cause at least a portion of the flow of the liquid chemical to pass through the membrane so that the membrane removes an amount of impurities or contaminants from the liquid chemical. The structure of a filter or filter cartridge may include one or more of various additional materials and structures that support the membrane within the filter to cause fluid to flow from a filter inlet, through the membrane, and thorough a filter outlet, thereby passing through the membrane when passing through the filter

Examples of useful filters and method for assembling the filters are described in International Patent Application Publication Number WO 2017/007683, the entirety of which is incorporated herein by reference.

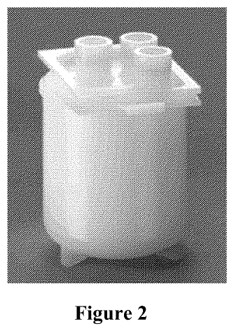

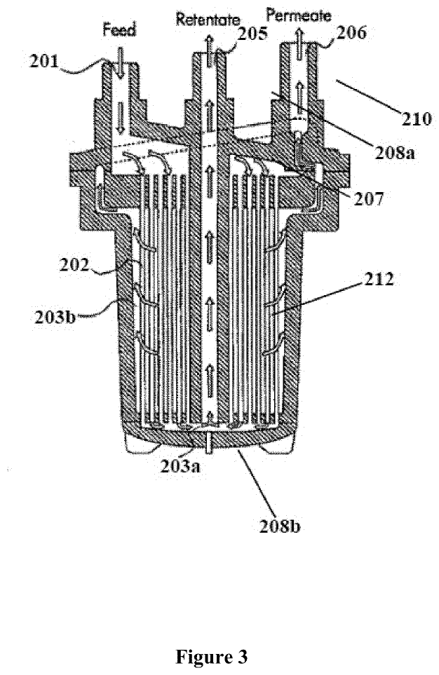

FIGS. 2 and 3 of the present application illustrate an example of a fluid separation device or filter that includes a membrane of the present description. FIG. 2 is an external view of a filter and FIG. 3 illustrates the membrane (multiple membranes) and the flow of liquid to be separated as the liquid enters and exits the fluid separation device. The fluid separation device (filter) includes housing 210, which contains multiple membranes 212. Each membrane 212 is potted at each of two opposed end regions to form a fluid-tight seal at the end regions, i.e., a seal between an edge at an end of the hollow membrane and a flat end piece that contains openings, to which the edge of the end is potted. The potting on the face of the fibers in the region 207 must remain open so that fluid can travel into, through, and out of the hollow interior of each membrane 212. The potted ends of the membrane, i.e., the potted connection of the edge of the end of each hollow fiber to the flat end piece (see FIG. 3), do not allow liquid to pass (leak) between the end of a hollow fiber membrane and the end piece. Each connection between a potted end of a hollow fiber membrane and the flat end piece is therefore “fluid-tight”—fluid (e.g., feed) is not allowed to leak past the end of a membrane 212 at the potted end of the membrane, into space 203b, without passing through the wall of the membrane.

In use, by one operating mode, a liquid feed enters the housing at opening 201, and is introduced to membranes 212 inside the housing. The membranes 212 separate the space within the housing into a first volume 203a and second volume 203b. Upon exposure of the liquid feed to the membranes 212, the permeate, which is material that passes through the membranes 212, enters the second volume 203b, and the retentate, the material that does not pass through the membrane 202, enters the first volume. The retentate can then be collected or filtered further upon extraction from the housing via connector 205. The permeate exits via a different connector 206, where is can be concentrated, disposed of, or recirculated back into the system.

In the filter embodiment of FIG. 3, a portion of the feed liquid passes through one of the membranes 212 to form the permeate, and another portion of the feed liquid passes through the filter without passing through a membrane 212. According to other filter embodiments, the entire amount of feed liquid will pass through membranes 212 to form the permeate, and no portion of the feed fluid by-passes the membranes 212 to form the retentate.

In an alternate mode of operation of a filter as illustrated, the liquid can enter the filter through connector 205 to flow into filter shell space 203b. Connector 206 is used to purge air and bubbles displaced by the entering fluid. The bottom of the fiber is completely potted, so there is no retentate recycle. Also sections 203b and 203a are connected or open to each other. Liquid crosses from 203b into 201 through the membrane 212. The liquid exits the filter through port 201. According to the filter of FIG. 3, port 205 is a feed port, port 206 is a purge port, and port 201 is a permeate port.

A filter housing can be of any useful and desired size, shape, and materials, and can preferably be a fluorinated or non-fluorinated polymer such as nylon, polyethylene, polypropylene, or fluorinated polymer such as a poly(tetrafluoroethylene-co-perfluoro(alkyvinylether)), TEFLON® perfluoroalkoxyalkane (PFA), perfluoromethylalkoxy (MFA), or another suitable fluoropolymer (e.g., perfluoropolymer).

### Examples

The following table shows performance data from two filter membranes (S1 and S2) made using liquid metal as a quenching liquid and a comparison of that performance data to membranes (C1, and C2) made using water as a quenching liquid.

| | | | | | Bubble | |
|---|---|---|---|---|---|---|
| | Quench | | Take up | Flow | Point | Retention |
| Exam- | Temp | Quenching | Speed | time | (psi) | 1 percent |
| ple | (Celsius) | liquid | (ft/min) | (s) | (data) | monolayer |
| C1 | 60 | Water | 100 | 8081 | 63 | 32 |
| C2 | 60 | Water | 100 | 8899 | 63 | 37 |
| S1 | 60 | Test Fluid | 65 | 34997 | 130 | 75 |
| | | A | | | | |
| S2 | 60 | Test Fluid | 100 | 32046 | 129 | 65 |
| | | A | | | | |

Each of Comparative 1, Comparative 2, Sample 1 (inventive), and Sample 2 (inventive) were prepared using a slurry containing 30% solids concentration by weight of ultra high molecular weight polyethylene (UPE) from Asahi Kasei. Two different grades of UPE in the following ratio were used: UH901/BM840 (75/25). The solids were dispersed in a liquid mixture of Dibutyl sebacate (DBS) and mineral oil (MO) with a DBS/MO ratio of 75/25. The preparation methods were the same other than the type of quenching liquid, as indicated. Test Fluid A was a liquid metal.

The data show that for the same quench bath temperature, the membrane formed using high thermal conductance liquid metal has a bubble point that is at least 100 percent higher than the membrane formed using water as the quenching liquid; i.e., the bubble point of the inventive membrane is twice the bubble point of the non-inventive membrane.

The tests for data of these Examples were performed as follows:

### Bubble Point Test

To measure the mean bubble point, a sample hollow fiber membrane is placed in a holder. Air is pressurized through the holder and the flow rate measured as a function of pressure. A low surface tension fluid, HFE-7200 (3M) is then introduced to the membrane to wet the membrane. Air is pressurized through the holder at the interior of the hollow fiber membrane, and the air flow is measured as a function of pressure. The mean bubble point is the pressure at which the ratio of the air flow of the wet membrane to the air flow of the dry membrane is 0.5. The test is performed at a temperature in a range of between 20 and 22 degrees Celsius.

### Coverage Test

“Particle retention” or “coverage” refers to the percentage of the number of particles that can be removed from a fluid stream by a membrane placed in the fluid pathway of the fluid stream. Particle retention of a sample filter membrane disc can be measured by passing a sufficient amount of an aqueous feed solution of 0.1% Triton X-100, containing 8 ppm polystyrene particles having a nominal diameter of 0.03 microns (available from Duke Scientific G25B), to achieve 1% monolayer coverage through a membrane at a constant flow of 7 mL/min, and collecting the permeate. The concentration of the polystyrene particles in the permeate can be calculated from the absorbance of the permeate. Particle retention is then calculated using the following equation:

$$particle retention = \frac{[ feed ] - [ filtrate ]}{[ feed ]} \times 100 \% .$$

The number (#) of particles necessary to achieve 1% monolayer coverage can be calculated from the following equation:

$$\# of particles for 1 \% monolayer = \frac{a}{\frac{\sqrt{3}}{2} {d}_{p}^{2}} \times \frac{1}{100}$$

$$where \\ a = effective membrane surface area$$

$${d}_{p} = diameter of the particle$$

“Nominal diameter,” as used herein, is the diameter of a particle as determined by photon correlation spectroscopy (PCS), laser diffraction or optical or SEM microscopy. Typically, the calculated diameter, or nominal diameter, is expressed as the diameter of a sphere that has the same projected area as the projected image of the particle. PCS, laser diffraction and optical microscopy techniques are well-known in the art. See, for example, Jillavenkatesa, A., et al.; “Particle Size Characterization;” NIST Recommended Practice Guide; National Institute of Standards and Technology Special Publication 960-1; January 2001.

### “Flow Time” Test (Using Isopropanol)

Isopropanol permeability (“flow”) can be determined using an internal flow test. The membrane is placed in a holder with the first side on the upstream. Isopropanol is fed through the sample at a specified pressure, i.e., 14.2 psi, for a predetermined interval at a temperature of 20 to 22 degrees C. Then, the isopropanol flowing through the membrane is collected and measured. Isopropanol permeability is calculated from the following equation:

$$P = \frac{V}{t \times a \times p}$$

$$where \text{:} \\ V = volume of isopropanol collected$$

$$t = time of collection$$

$$a = effective membrane surface area$$

$$p = pressure drop across the membrane$$

Further, flow time is defined as the time it takes to collect 500 ml of fluid through a membrane with a surface area of 13.8 cm² at 14.2 psi. So a fixed volume of IPA (V) can be collected for a time (t) using a given membrane surface area (a) at 14.2 psi. The flow time (T) can be calculated using the following equation:

$$T = t * \frac{a}{13.8} * \frac{500}{V}$$

As shown by the performance data, the inventive examples exhibit improved filtering performance relative to the commercially available comparative filters.

In a first aspect, a method of preparing a polymeric porous membrane is disclosed, the method comprising: extruding polymer solution comprising polymer and solvent, at an extrusion temperature, to form an extruded hollow fiber, and reducing the temperature of the extruded hollow fiber by contacting the extruded hollow fiber with a liquid metal.

A second aspect according to the first aspect, wherein the liquid metal is at a temperature below 100 degrees Celsius.

A third aspect according to the first or second aspect, wherein the liquid metal has a melting point below 100 degrees Celsius.

A fourth aspect according to any preceding aspect, wherein the liquid metal has a melting point below 50 degrees C.

A fifth aspect according to any preceding aspect, wherein the liquid metal comprises: at least 50 weight percent gallium, at least 5 weight percent tin, and at least 10 weight percent indium.

A sixth aspect according to any preceding aspect, wherein the liquid metal comprises: from 65 to 72 weight percent gallium, from 5 to 15 weight percent tin, and from 15 to 25 weight percent indium.

A seventh aspect according to any preceding aspect, wherein the extrusion temperature is at least 180 degrees Celsius.

An eighth aspect according to any preceding aspect, wherein the polymer comprises thermoplastic polymer selected from the group consisting of: a polyolefin, a fluorinated polymer, a perfluorinated polymer, a nylon, a polysulfones, and combinations thereof.

A ninth aspect according to any preceding aspect, wherein the polymer is polyethylene.

A tenth aspect according to any preceding aspect, wherein the polymer is polyvinylidene fluoride, ethylene-tetrafluoro-ethylene, fluorinated ethylene-propylene, or nylon.

An eleventh aspect according to any preceding aspect, wherein the polymer solution comprises: from 10 to 40 weight percent polymer, and from 60 to 90 weight percent solvent, based on total weight polymer solution.

A twelfth aspect according to any preceding aspect, wherein the solvent comprises: a first solvent in which the polymer is soluble, at the extrusion temperature, and a second solvent in which the polymer is less soluble that the first solvent, at the extrusion temperature.

A thirteenth aspect according to any preceding aspect, wherein the polymeric porous membrane has pores of an average size in a range from 0.01 to 10 microns.

A fourteenth aspect according to any preceding aspect, wherein the polymeric porous membrane has a bubble point that is greater than a bubble point of a comparable porous membrane formed by an identical process and material but by reducing the temperature of the extruded hollow fiber by contacting the extruded hollow fiber with water.

A fifteenth aspect according to any preceding aspect, wherein the polymeric porous membrane has a bubble point of at least 50 pounds per square inch when measured using HFE-7200 liquid fluid at a temperature of 22 degrees Celsius.

A sixteenth aspect according to any preceding aspect, wherein the porous membrane has a thickness in a range from 10 to 1000.

In a seventeenth aspect, a method of preparing a polymeric porous membrane is disclosed, the method comprising: extruding polymer solution comprising polymer and solvent, at an extrusion temperature, to form an extruded hollow fiber, and reducing the temperature of the extruded hollow fiber by contacting the extruded hollow fiber with a liquid having a thermal conductivity of at least 3 watts per meter per degree Kelvin.

An eighteenth aspect according to the seventeenth aspect, wherein the liquid is a liquid metal and the liquid metal is at a temperature below 100 degrees Celsius.

A nineteenth aspect according to the seventeenth or eighteenth aspect, wherein the liquid is a liquid metal having a melting point below 100 degrees Celsius.

A twentieth aspect according to any of the seventeenth through nineteenth aspects, wherein the liquid metal has a melting point below 50 degrees C.

A twenty-first aspect according to any of the seventeenth through twentieth aspects, wherein the liquid is a liquid metal comprising at least 50 weight percent gallium, at least 5 weight percent tin, and at least 10 weight percent indium.

A twenty-second aspect according to any of the seventeenth through twenty-first aspects, wherein the liquid is a liquid metal comprising: from 65 to 72 weight percent gallium, from 5 to 15 weight percent tin, and from 15 to 25 weight percent indium.

A twenty-third aspect according to any of the seventeenth through twenty-second aspects, wherein the extrusion temperature is at least 180 degrees Celsius.

A twenty-fourth aspect according to any of the seventeenth through twenty-third aspects, wherein the polymer comprises thermoplastic polymer selected from the group consisting of: a polyolefin, a fluorinated polymer, a perfluorinated polymer, a nylon, a polysulfones, and combinations thereof.

A twenty-fifth aspect according to any of the seventeenth through twenty-fourth aspects, wherein the polymer is polyethylene.

A twenty-sixth aspect according to any of the seventeenth through twenty-fifth aspects, wherein the polymer is polyvinylidene fluoride, ethylene-tetrafluoro-ethylene, fluorinated ethylene-propylene, or nylon.

A twenty-seventh aspect according to any of the seventeenth through twenty-sixth aspects, wherein the polymer solution comprises: from 10 to 40 weight percent polymer, and from 60 to 90 weight percent solvent, based on total weight polymer solution.

A twenty-eighth aspect according to any of the seventeenth through twenty-seventh aspects, wherein the solvent comprises: a first solvent in which the polymer is soluble, at the extrusion temperature, and a second solvent in which the polymer is less soluble that the first solvent, at the extrusion temperature.

A twenty-ninth aspect according to any of the seventeenth through twenty-eighth aspects, wherein the polymeric porous membrane has pores of an average size in a range from 0.01 to 10 microns.

A thirtieth aspect according to any of the seventeenth through twenty-ninth, wherein the polymeric porous membrane has a bubble point that is greater than a bubble point of a comparable porous membrane formed by an identical process and material but by reducing the temperature of the extruded hollow fiber by contacting the extruded hollow fiber with water.

A thirty-first aspect according to any of the seventeenth through thirtieth aspects, wherein the polymeric porous membrane has a bubble point of at least 50 pounds per square inch when measured using HFE-7200 liquid fluid at a temperature of 22 degrees Celsius.

A thirty-second aspect according to any of the seventeenth through thirty-first aspects, wherein the porous membrane has a thickness in a range from 10 to 1000.

In a thirty-third aspect, a porous membrane prepared by a method of any of the first through thirty-second aspects is disclosed.

In thirty-fourth aspect, a filter cartridge that includes the porous membrane of the thirty-third aspect is disclosed.

In a thirty-fifth aspect, a filter that includes the porous membrane of third-third aspect is disclosed.

In a thirty-sixth aspect, a method of using the porous membrane of the thirty-third aspect, the filter cartridge of the thirty-fourth aspect, or the filter of the thirty-fifth aspect, the method comprising passing solvent-containing liquid through the filter membrane is disclosed.

A thirty-seventh aspect according to the thirty-sixth aspect, wherein the solvent-containing liquid is a semiconductor lithography solvent.

A thirty-eighth aspect according to the thirty-sixth or thirty-seventh aspect, wherein the solvent is selected from the group consisting of: ethyl lactate, gamma-butyrolactone, hexamethyldisilazane, methyl-2-hydroxyisobutyrate, isopropyl alcohol, methyl isobutyl carbinol, n-butyl acetate, tetraethyl ammonium hydroxide (TMAH), propylene glycol methyl ether (PGME), propylene glycol methylether acetate (PGMEA), isoamyl acetate, 2-heptanone, cyclohexanone, and combinations thereof.

1. A method of preparing a polymeric porous membrane, the method comprising:
extruding polymer solution comprising polymer and solvent, at an extrusion temperature, to form an extruded hollow fiber, and
reducing the temperature of the extruded hollow fiber by contacting the extruded hollow fiber with a liquid metal.

2. The method of claim 1, wherein the liquid metal is at a temperature below 100 degrees Celsius.

3. The method of claim 1, wherein the liquid metal has a melting point below 100 degrees Celsius.

4. The method of claim 1, wherein the liquid metal has a melting point below 50 degrees C.

5. The method of claim 1, wherein the liquid metal comprises:
at least 50 weight percent gallium,
at least 5 weight percent tin, and
at least 10 weight percent indium.

6. The method of claim 1, wherein the liquid metal comprises:
from 65 to 72 weight percent gallium,
from 5 to 15 weight percent tin, and
from 15 to 25 weight percent indium.

7. The method of claim 1, wherein the extrusion temperature is at least 180 degrees Celsius.

8. The method of claim 1, wherein the polymer comprises thermoplastic polymer selected from the group consisting of: a polyolefin, a fluorinated polymer, a perfluorinated polymer, a nylon, a polysulfones, and combinations thereof.

9. The method of claim 1, wherein the polymer is polyethylene.

10. The method of claim 1, wherein the polymer is polyvinylidene fluoride, ethylene-tetrafluoro-ethylene, fluorinated ethylene-propylene, or nylon.

11. The method of claim 1, wherein the polymer solution comprises:
from 10 to 40 weight percent polymer, and
from 60 to 90 weight percent solvent, based on total weight polymer solution.

12. The method of claim 1, wherein the solvent comprises:
a first solvent in which the polymer is soluble, at the extrusion temperature, and
a second solvent in which the polymer is less soluble that the first solvent, at the extrusion temperature.

13. The method of claim 1, wherein the polymeric porous membrane has pores of an average size in a range from 0.01 to 10 microns.

14. The method of claim 1, wherein the polymeric porous membrane has a bubble point that is greater than a bubble point of a comparable porous membrane formed by an identical process and material but by reducing the temperature of the extruded hollow fiber by contacting the extruded hollow fiber with water.

15. The method of claim 1, wherein the polymeric porous membrane has a bubble point of at least 50 pounds per square inch when measured using HFE-7200 liquid fluid at a temperature of 22 degrees Celsius.

16. A porous membrane prepared by the method of claim 1.

17. A filter cartridge that includes the porous membrane of claim 16.

18. A filter that includes the porous membrane of claim 16.

19. A method of using the porous membrane of claim 16, the method comprising passing solvent-containing liquid through the porous membrane.

20. A method of preparing a polymeric porous membrane, the method comprising:
extruding polymer solution comprising polymer and solvent, at an extrusion temperature, to form an extruded hollow fiber, and
reducing the temperature of the extruded hollow fiber by contacting the extruded hollow fiber with a liquid having a thermal conductivity of at least 3 watts per meter per degree Kelvin.
